(19) United States
(12) Patent Application Publication
(10) Pub. No.: US 2026/0254598 A1
(43) Pub. Date: Aug. 27, 2026

(54) METHODS AND PROCEDURES TO ENABLE PAGING FOR LOW LATENCY SUPPORT IN WLAN

(71) Applicant: InterDigital Patent Holdings, Inc., Wilmington, DE (US)

(72) Inventors: Mahmoud SAAD, Montreal (CA); Zinan LIN, Basking Ridge, NJ (US); Rui YANG, Melville, NY (US); Hanqing LOU, Syosset, NY (US); Xiaofei WANG, North Caldwell, NJ (US); Joseph LEVY, Merrick, NY (US)

(73) Assignee: InterDigital Patent Holdings, Inc., Wilmington, DE (US)

(21) Appl. No.: 19/160,349

(22) PCT Filed: Mar. 1, 2024
(86) PCT No.: PCT/US2024/017971

§ 371 Date: Aug. 27, 2025

Related U.S. Application Data
(60) Provisional application No. 63/449,479, filed on Mar. 2, 2023.
(60) Provisional application No. 63/537,104, filed on Sep. 7, 2023.

(51) Int. Cl. H04L 5/00

(52) U.S. Cl. CPC H04L 5/0094; H04L 5/0007

(57) ABSTRACT

A station (STA) may support a low latency data transmission. The STA is configured to receive a preamble that comprises a low latency data transmission resource present subfield. The STA is configured to determine, based on the low latency data transmission resource present subfield, that resources are allocated for a low latency data transmission. The STA is configured to monitor the allocated resources for the low latency data transmission. The STA is configured to receive control information in a physical layer protocol data unit (PPDU) in the allocated resources for the low latency data transmission. The STA is configured to decode the received control information. The STA is configured to determine that the control information is addressed to the STA. The STA is configured to receive the low latency data transmission over the allocated resources for the low latency data transmission based on the control information.

### CROSS-REFERENCE TO RELATED APPLICATIONS

This application claims the benefit of U.S. Provisional Application No. 63/537,104, filed Sep. 7, 2023 and U.S. Provisional Application No. 63/449,479, filed Mar. 2, 2023, the contents of which are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA.

### SUMMARY

A station (STA) may support a low latency data transmission. The STA is configured to receive a preamble that comprises a low latency data transmission resource present subfield. The STA is configured to determine, based on the low latency data transmission resource present subfield, that resources are allocated for a low latency data transmission. The STA is configured to monitor the allocated resources for the low latency data transmission. The STA is configured to receive control information in a physical layer protocol data unit (PPDU) in the allocated resources for the low latency data transmission. The STA is configured to decode the received control information. The STA is configured to determine that the control information is addressed to the STA. The STA is configured to receive the low latency data transmission over the allocated resources for the low latency data transmission based on the control information. The low latency data transmission resource present subfield comprises an indication that indicates whether low latency data transmission resources are present. The low latency data transmission resource present subfield is in a U-SIG field or a UHR-SIG field. The allocated resources for the low latency data transmission are static resources and are known to the STA. The allocated resources for the low latency data transmission are signaled dynamically in a SIG field of the received preamble. The low latency data transmission is received in the PPDU. The PPDU is a paging PPDU. The resources for low latency data transmission is a communication channel for low latency data transmission. The resources for low latency data transmission is at least one or more orthogonal frequency division multiple access (OFDMA) resource units (RUs). The allocated resources for the low latency data transmission is a low latency paging channel (LLPC).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example EHT-SIG content channel format for OFDMA transmission if the bandwidth is 20/40/80 MHz;

FIG. 3 shows an example EHT-SIG content channel format for OFDMA transmission if bandwidth is 160 MHZ;

FIG. 4 shows an example EHT-SIG content channel format for OFDMA transmission if the bandwidth is 320 MHz;

FIG. 5 shows an example EHT-SIG content channel format for non-OFDMA transmission to multiple users;

FIG. 6A shows an example data packet in a situation where low latency (LL) traffic arrives and no paging resource is allocated;

FIG. 6B shows an example design of a paging channel where LL traffic arrives and paging resources are allocated;

FIG. 7 shows an example allocation of a low latency paging channel (LLPC) in an 80 MHz channel;

FIG. 8 is an example Paging PPDU transmitted via DL OFDMA from an AP to a non-AP STA;

FIG. 9 is an example Paging PPDU with repeated End of LL Data fields transmitted via DL OFDMA from an AP to a non-AP STA;

FIG. 10 is an example Paging PPDU that carries data to multiple STAs;

FIG. 11 is an example of a Paging PPDU transmission within a TXOP;

FIG. 12 is an example LL Traffic Membership Status Array field format;

FIG. 13 is an example of a LL Group ID Management frame Action field format;

FIG. 14 shows an example method for a transmitter supporting a LLPC feature;

FIG. 15 shows an example method for a receiver supporting a LLPC feature; and

FIG. 16 shows an example method for a receiver STA supporting a low latency data transmission.

### DETAILED DESCRIPTION

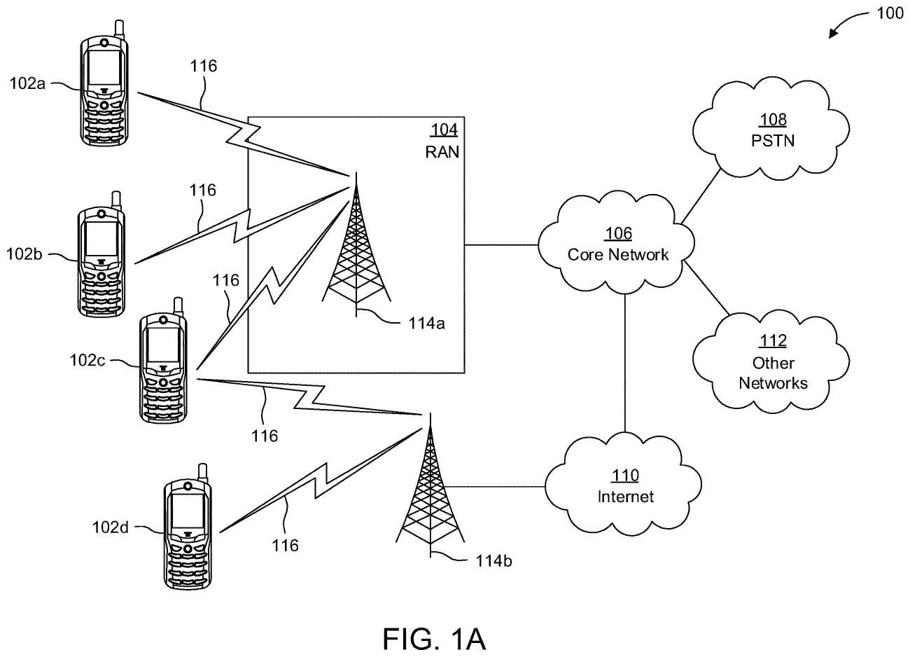

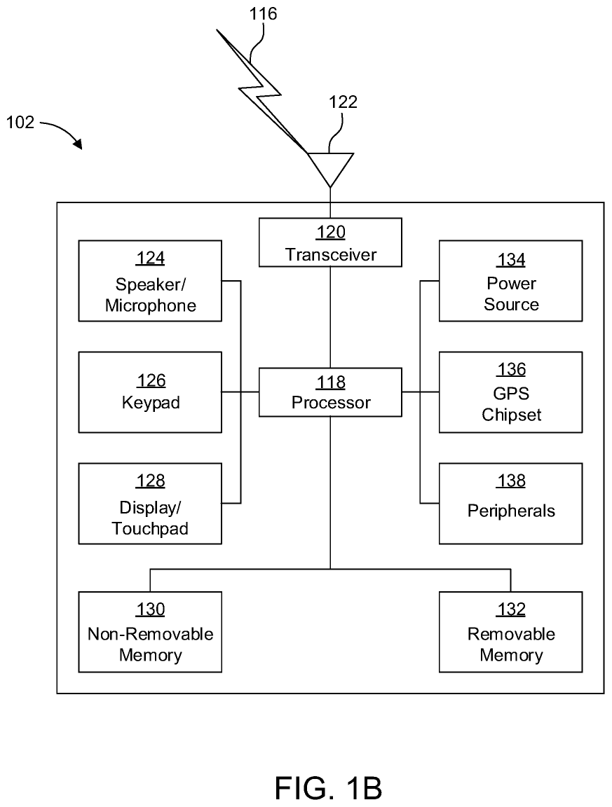

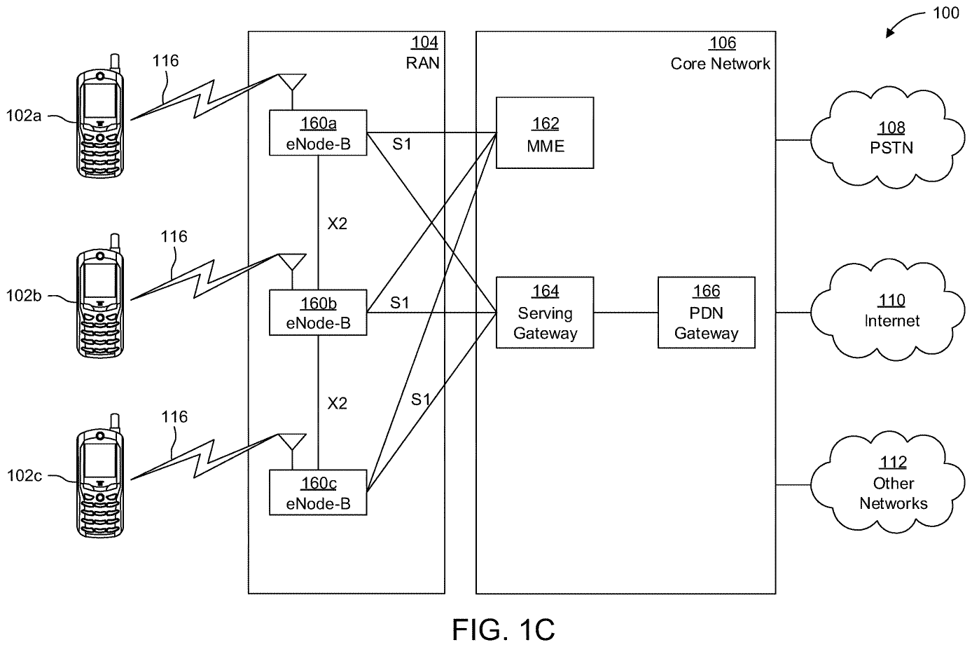

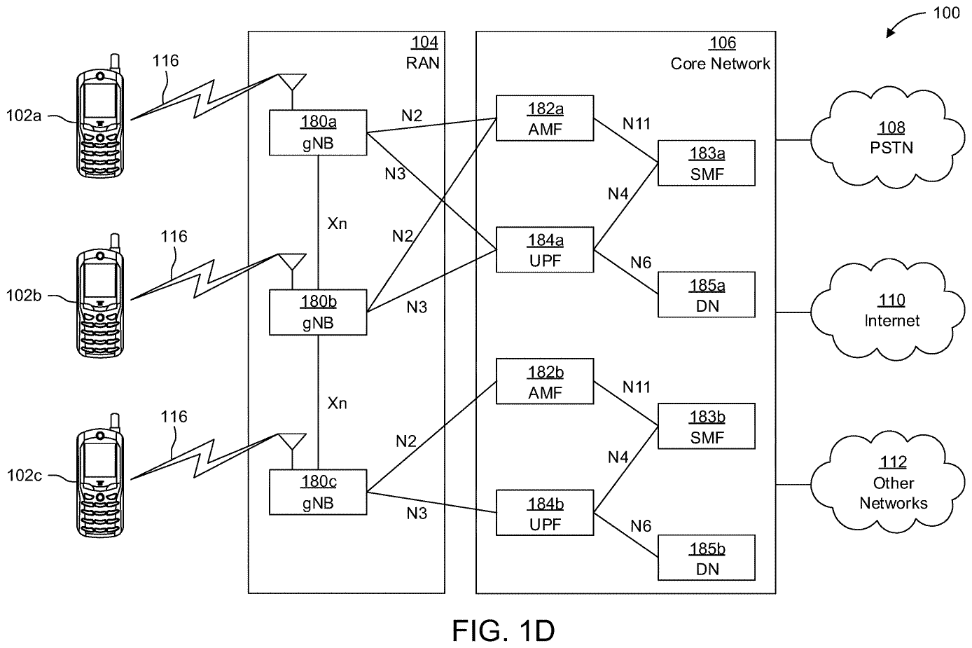

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using an 802.11ac infrastructure mode of operation, an AP may transmit a beacon on a fixed channel, such as a primary channel. This channel may be 20 MHz wide, and may be the operating channel of the BSS. This channel may also be used by the STAs to establish a connection with the AP. A channel access mechanism in an 802.11 system is Carrier Sense Multiple Access with Collision Avoidance (CSMA/CA). In this mode of operation, every STA, including the AP, may sense the primary channel. If the channel is detected to be busy, the may STA back off. Hence only one STA may transmit at any given time in a given BSS.

In 802.11n, High Throughput (HT) STAs may also use a 40 MHz wide channel for communication. This may be achieved by combining a primary 20 MHz channel with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels may be formed by combining contiguous 20 MHz channels similar to 802.11n. A 160 MHz channel may be formed by combining eight contiguous 20 MHz channels or by combining two non-contiguous 80 MHz channels, which may also be referred to as an 80+80 configuration. For the 80+80 configuration, the data, after channel encoding, may be passed through a segment parser that may divide it into two streams. An inverse Discrete Fourier Transformation (IDFT) operation and time-domain processing may be done on each stream separately. The streams may then be mapped to the two channels, and the data may be transmitted. At the receiver, this procedure is reversed and the combined data may be sent to the MAC.

To improve spectral efficiency 802.11ac has introduced the concept for downlink Multi-User MIMO (MU-MIMO) transmission to multiple STA's in the same symbol's time frame, for example, during a downlink OFDM symbol. The potential for the use of downlink MU-MIMO is also currently considered for 802.11ah. Since downlink MU-MIMO, as it is used in 802.11ac, uses the same symbol timing to multiple STA's, interference of the waveform transmissions to multiple STA's is not an issue. However, all STA's involved in MU-MIMO transmission with the AP must use the same channel or band, and this limits the operating bandwidth to the smallest channel bandwidth that is supported by the STA's which are included in the MU-MIMO transmission with the AP.

IEEE 802.11 UHR Study Group was formed to create a project authorization request (PAR) to create an 802.11 Task Group to standardize improved reliability of WLAN connectivity, reduce latencies, increase manageability, and increase throughput consumption. Several features are proposed to be included in the PAR including: supporting a maximum aggregated throughput of at least 100 Gbps; supporting at least two times improvement in aggregated throughput at every signal to noise ratio (SNR) level, measured at the MAC data service access point, compared to 802.11be; defining at least one mode of operation capable of improved latency bound and jitter at the 99 to 99.9999th percentiles compared to 802.11be; satisfying real-time applications requirements for high reliability in the presence of overlapping BSSs and for seamless BSS transitions within an ESS; and enabling backward compatibility and coexistence with legacy IEEE 802.11 devices operating in license-exempt bands between 1 and 7.250 GHz and enabling coexistence with legacy IEEE 802.11 devices operating in license-exempt bands between 42.5 and 71 GHz.

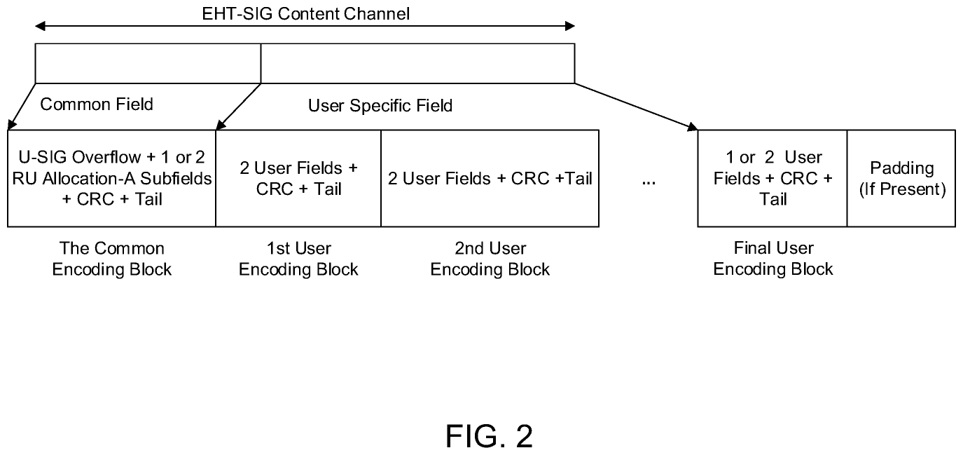

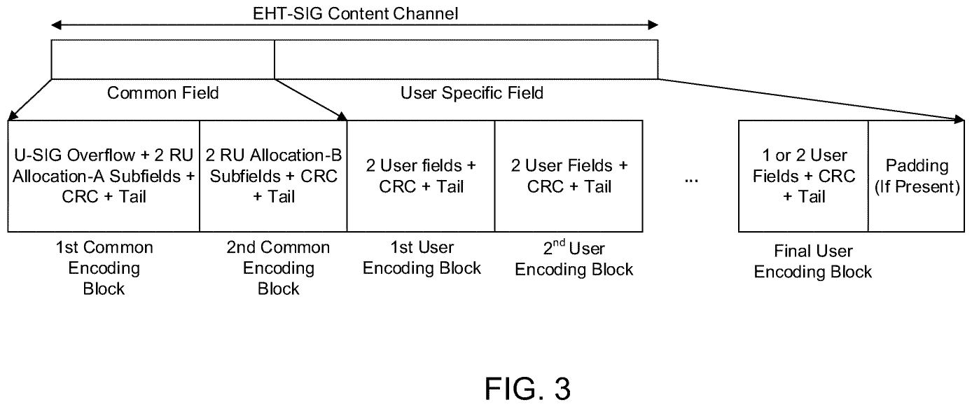

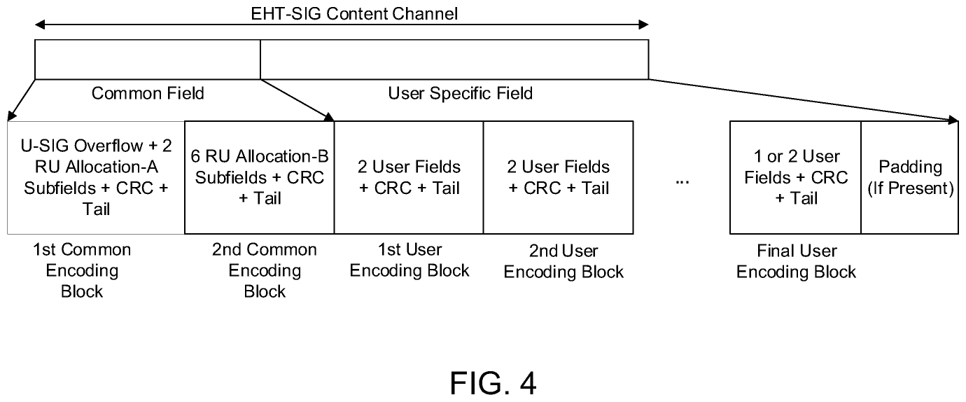

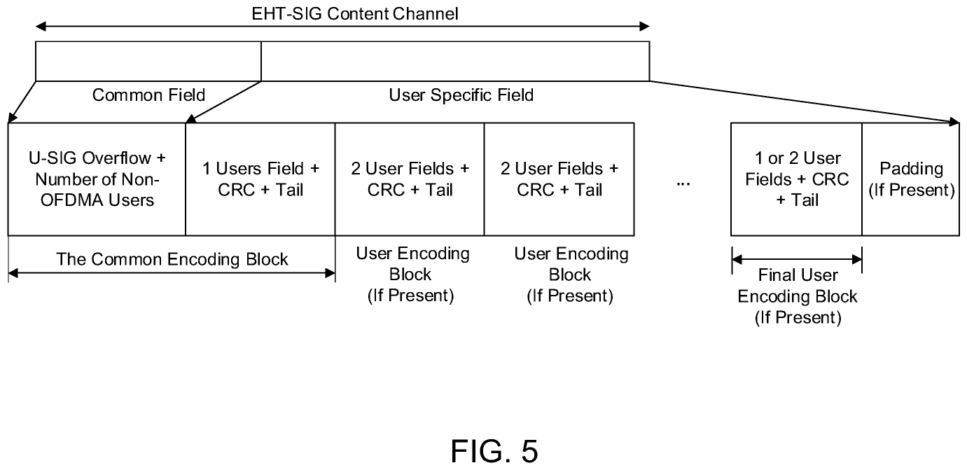

An EHT-SIG field is an example of a SIG field that may be used to provide signaling for the STAs to interpret the resource allocation in a PPDU. The EHT-SIG field of a 20 MHz EHT MU PPDU may comprise one EHT-SIG content channel. For OFDMA transmission and for non-OFDMA transmission to multiple users, the EHT-SIG field of an EHT MU PPDU that is 40 MHz or 80 MHz comprises two EHT-SIG content channels. For OFDMA transmission and for non-OFDMA transmission to multiple users, the EHT-SIG field of an EHT MU PPDU that is 160 MHz or wider comprises two EHT-SIG content channels per 80 MHz frequency subblock. The EHT-SIG content channels per 80 MHz frequency subblock are allowed to carry different information when EHT MU PPDU bandwidth for OFDMA transmission is wider than 80 MHz. The EHT-SIG field of an EHT SU transmission or the EHT-SIG field of an EHT sounding NDP comprises one EHT-SIG content channel, and it is duplicated in each non-punctured 20 MHz subchannel when the EHT PPDU is equal to or wider than 40 MHz. Different examples of the EHT-SIG content channels are shown in FIGS. 2-5. FIG. 2 shows an example EHT-SIG content channel format for OFDMA transmission if the bandwidth is 20/40/80 MHz. FIG. 3 shows an example EHT-SIG content channel format for OFDMA transmission if bandwidth is 160 MHz. FIG. 4 shows an example EHT-SIG content channel format for OFDMA transmission if the bandwidth is 320 MHz. FIG. 5 shows an example EHT-SIG content channel format for non-OFDMA transmission to multiple users.

Interruption of ongoing transmissions to accommodate low latency traffic may be costly in terms of resources. Paging of STAs with low latency traffic during an ongoing transmission may be more efficient and may avoid interrupting the ongoing transmissions. A resource or resources may be allocated and used as a paging channel in the ongoing transmission and signaling may be required to manage the operation of this paging operation. A procedure to enable a paging channel or channels which may be used to accommodate low latency traffic in, for example, 802.11 is an open problem. Methods and procedures are needed to enable a paging channel for low latency traffic in WLANs.

Low latency traffic may arrive at an AP, for STAs that support receiving low latency traffic, in the middle of an ongoing transmission which may be a long transmission (e.g. maximum PPDU Time in EHT is 5.484 ms). For sub-millisecond latency applications, long transmissions would introduce unacceptable latencies. Interruption of ongoing long transmissions to accommodate low latency traffic may be costly in terms of resources.

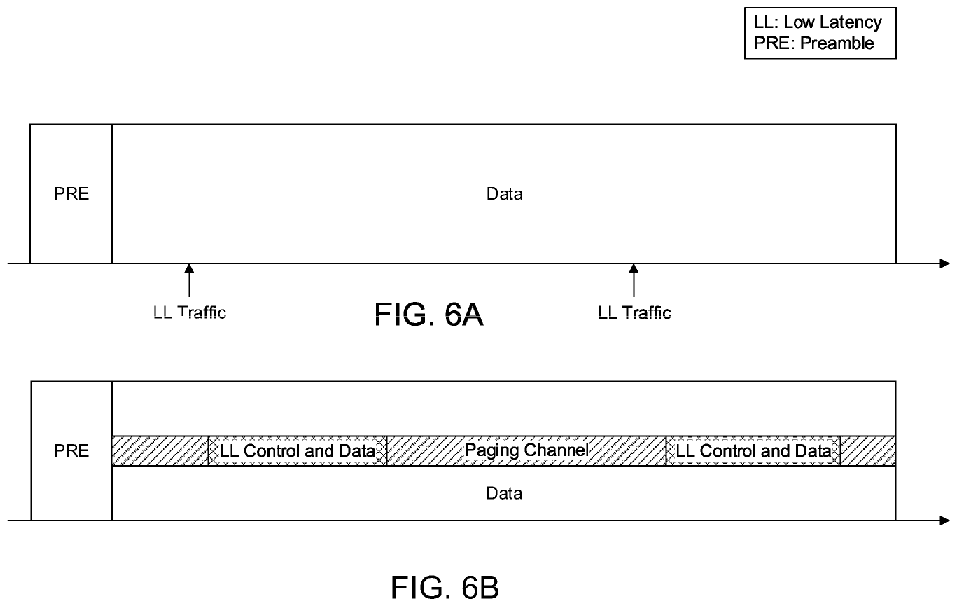

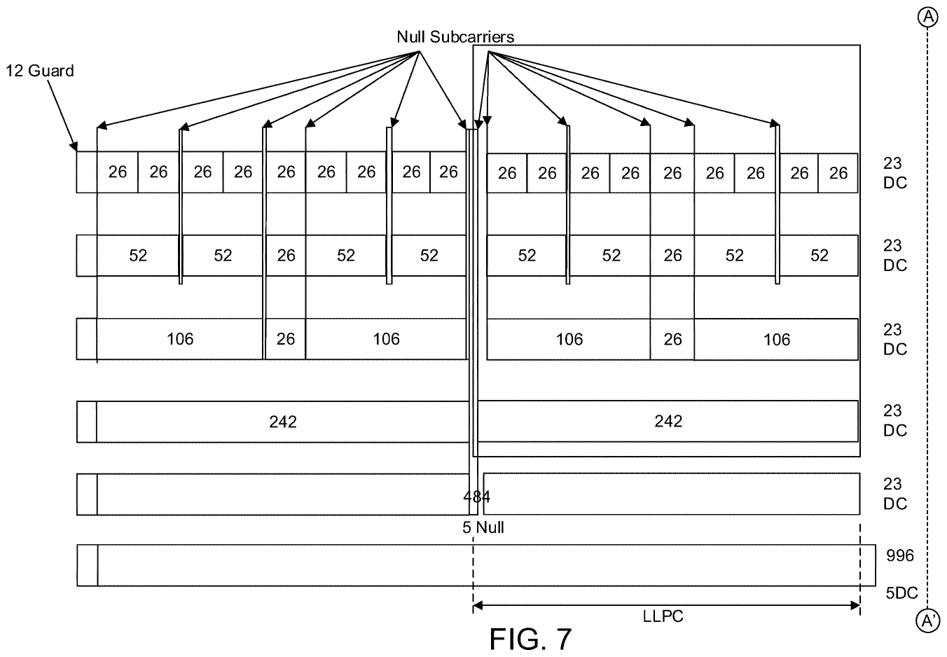

In an embodiment, a paging channel (i.e. low latency paging channel (LLPC)) may be introduced in long transmissions to send control information and/or low latency traffic for potential low latency STAs (i.e. STAs that support low latency traffic). The paging channel may be comprised of a resource unit (RU), multiple resource unit (MRU) or a subchannel that is dedicated for this purpose or dynamically controlled to accommodate low latency traffic or other types of traffic, as shown in FIG. 6. FIG. 6a shows a data packet in a situation that no paging resource is allocated to react where LL traffic has arrived at the transmitter side of the packet. FIG. 6b shows the data packet in a situation where a paging feature is introduced and there is a resource or resources allocated to transmit the LL traffic that has arrived (i.e. LL Control and Data). The LL traffic arrives and fills the allocated resources and the hatched area refers to padding to fill the resources allocated to the paging channel not filled by the LL control and data.

In an embodiment, the LLPC may be present in the ongoing transmission or not present in the ongoing transmission depending on whether low latency traffic is expected during this transmission or not, respectively. An early indication of the presence of the LLPC in a current transmitted PPDU may be indicated in a SIG field(s) of the PPDU.

In an embodiment, the indication of the presence of LLPC may be in a U-SIG field or UHR-SIG field, or any SIG field that may be used to signal information about the current PPDU. The indication of the presence LLPC may be in a subfield of the U-SIG field or UHR-SIG field, or any SIG field that may be used to signal information about the current PPDU. The subfield may be named, for example, LLPC Present. The LLPC Present subfield may be set to a value (e.g. “1”) to indicate that the LLPC channel is present in this PPDU and may be set to a different value (e.g. “0”) to indicate that the LLPC channel is not present in this PPDU.

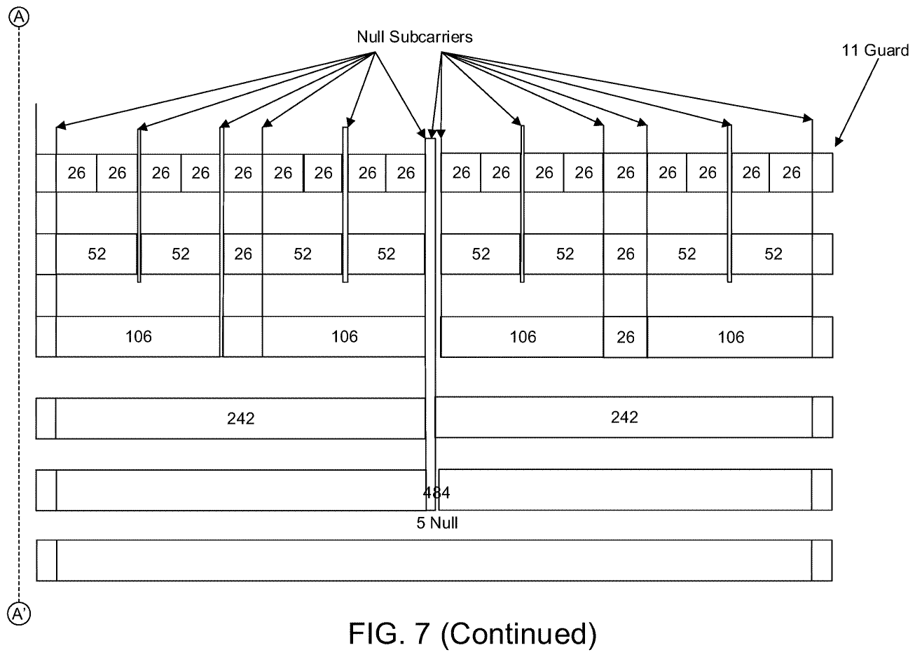

In an embodiment, the resource or resources allocated to be used for the LLPC may be a given 20 MHz subchannel in an 80 MHz channel or it may be a given 20 MHz subchannel in an 80 MHz subblock of a 160 or 320 MHz channel, as shown in FIG. 7, which shows an example allocation of a LLCP in an 80 MHz channel. The resource allocated for the LLPC may be a small RU (such as 26, 52, or 106-tones RUs) or a small MRU (such as 106+26-tones MRUs). The resource allocated for the LLPC may be an RU or MRU that is larger than 20 MHz.

In an embodiment, an allocated resource or resources for an LLPC in a current transmission may be static such that the resource location is known or may be dynamic and the resource location may be signaled in the SIG fields or subfields (e.g. U-SIG, UHR-SIG, or any SIG field that may be used to signal information about the current PPDU).

In an embodiment, an LLPC may be used to send control information for the STAs expecting low latency traffic. The control information may be, for example, STA information to identify which STAs may receive low latency traffic in the ongoing transmission. In an embodiment, the LLPC may be used to send the low latency traffic addressed to the STAs expecting the low latency traffic.

In an embodiment, the allocated resource or resources for an LLPC may be chosen or determined such that the STAs supporting this feature may need to monitor only a portion of the BSS bandwidth where the LLPC is transmitted and not the entire bandwidth, which may save energy. In an example, the primary 20 MHz channel of the BSS may be allocated for the LLPC during the ongoing transmission.

In an embodiment, an LLPC may be dedicated only for low latency control information and traffic such that it may be padded if there is no low latency traffic arriving during the ongoing transmission. An indication for the padding may be included in the control information transmitted over the LPCC. In an example, the padding may be in a bit-level by padding with known sequence of bits, such as all zeros. In an example, the padding may be in a symbol-level by padding with whole symbols where the padding symbols may be of a known sequence, such as LTFs.

In an embodiment, an LLPC may be scheduled for other transmissions in case no low latency traffic arrived during the ongoing transmission. In this case, control information may be sent over the LLPC to indicate the identity of the STA receiving data over the LLPC. In an embodiment, the LPCC may be left empty if there is no low latency traffic arrived during the ongoing transmission. In this case, the LLPC may be considered as a punctured subchannel.

In an embodiment, the low latency control information sent on the LLPC may include allocation information to allocate the LLPC resource or resources for one or more STAs receiving the low latency traffic which follows the control information. The control information may also include STA information to identify the STAs receiving the low latency traffic.

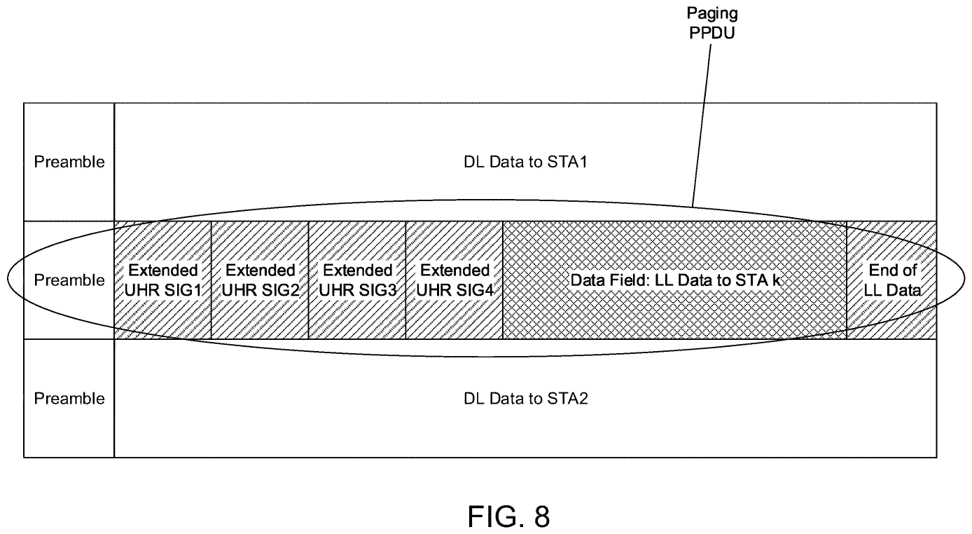

In an embodiment of a PPDU design, the PPDU transmitted in the paging channel may be called a Paging PPDU. In a downlink transmission (i.e., from an AP to a non-AP STA) the preamble fields of the Paging PPDU, for example L-STF, L-LTF, L-SIG, RL-SIG, U-SIG, EHT-SIG, EHT-STF and EHT-LTF, may be aligned with preambles of EHT PPDUs transmitted in other RUs (or channels). FIG. 8 shows an exemplary Paging PPDU transmitted in the downlink using, for example, OFDMA. In this example, the AP transmits DL data to STA1 and STA2 and reserves a paging channel for a Paging PPDU transmission. In the Paging PPDU, a UHR Extended SIG fields may follow the legacy preamble. The number of UHR SIG fields may not be fixed (i.e. it may be variable). FIG. 8 shows four Extended UHR SIG fields as an example, but there may be more or less Extended UHR SIG fields. The formats of the Extended UHR SIG1 field, the Extended UHR SIG2 field, the Extended UHR SIG3 field, and the Extended UHR SIG4 field may be the same. The data field may start after the traffic assigned to this paging channel comes to the buffer (e.g., ultra-low latency traffic). The potential recipient STAs of the low latency traffic may be STA1, STA2 or any other STA. A LL Group ID of the potential LL recipient STAs of the paging PPDU may be carried in a legacy preamble. For example, it may be carried in B20-B24 in the U-SIG field of the EHT MU PPDU. When the value of B20-B24 is not set to a value of 1, then it may represent a LL group ID which is assigned to a group of potential LL traffic recipient STAs. If the STA detects its LL group ID indicated in the U-SIG field of the EHT MU PPDU, then it may need to decode the Extended UHR SIG1, Extended UHR SIG2, etc. until it detects an AID value that matches its own AID or it detects the AID value that is not a special value anymore. The special value in the AID subfield of the Extended UHR SIG (e.g., AID=0) may imply that this Extended UHR SIG field is followed by another Extended UHR SIG field. If the AID subfield of the Extended UHR SIG is set to the AID address of a STA, then it may indicate that there is no more Extended UHR SIG fields, and the data field will follow this Extended UHR SIG field. In the example of FIG. 8, there are four Extended UHR SIG fields. The AID subfields of the first three Extended UHR SIG fields may be set to 0, and the AID subfield of Extended UHR SIG4 field may be set to the AID of STA k. If STA k identifies or determines that the value in the AID subfield matches its AID value, it may continue to decode the Data field that follows the Extended UHR SIG4 field. If a STA finds that it is not a member of the LL Group ID indicated in the Paging PPDU, that STA may choose to not process the remainder of the PPDU. Other STAs which belong to the LL Group ID and identifies or determines that the AID value set in the AID subfield of the Extended UHR SIG4 field does not match its AID, that STA may choose not to process the Data field that follows the Extended UHR SIG4 field.

In an embodiment, a predefined sequence may be transmitted in an Extended UHR SIG field before the data field starts. If a STA decodes the predefined sequence, it may indicate that this STA is the receiver of the LL data that follows the Extended UHR SIG field.

In an embodiment, a LL Data Indication subfield may be carried in the Extended UHR SIG field. If it is set to a particular value (e.g. a value of 1), it may indicate that LL data follows this Extended UHR SIG field. Otherwise, if the LL Data indication subfield is set to a different value (e.g. a value of 0), it may indicate that another Extended UHR SIG field follows this Extended UHR SIG field. In the example of FIG. 8, the LL Data Indication subfields in Extended UHR SIG1, Extended UHR SIG2, Extended UHR SIG3 may be set to 0. The LL Data Indication subfield of Extended UHR SIG4 may be equal to a value of 1 to indicate that the data field follows the Extended UHR SIG4 subfield.

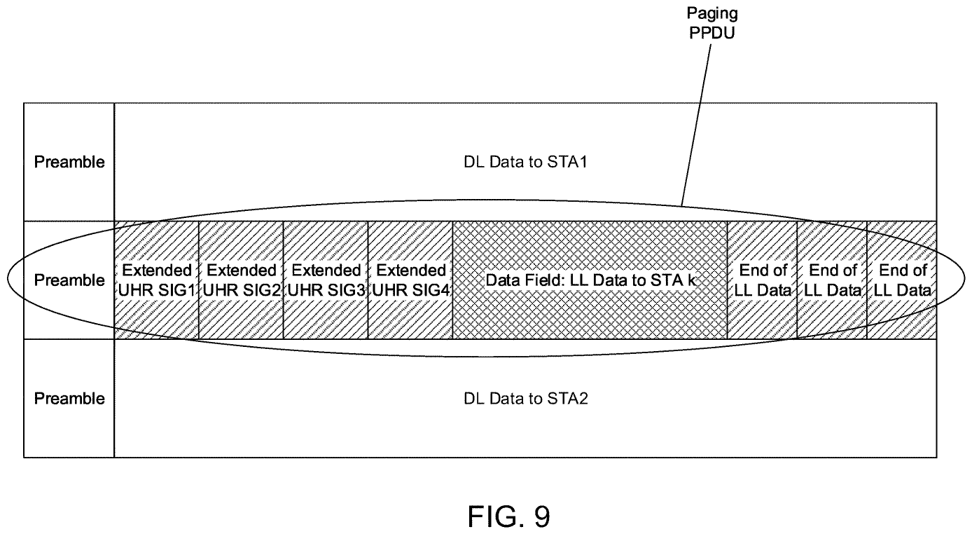

An End of LL Data field may follow the Data field in the Paging PPDU. This field may indicate the end of transmission of LL data in the current Paging PPDU. If LL Data to STA k does not last as long as the legacy PPDU transmission in another channel or RU, it may terminate earlier and multiple End of LL Data fields may be repeated until the last one aligns with the ending of PPDUs allocated in other channels or RUs. An example of a Paging PPDU transmitted in the downlink via OFDMA with repeated End of LL Data fields is shown in FIG. 9. In the example of FIG. 9, three End of LL Data fields are transmitted to align DL transmissions from AP to STA1 and AP to STA2. In other words, the last End LL Data field ends at the same time as the Data field to STA1 and Data field to STA2.

In an embodiment, the end of LL data transmission may be indicated by a Packet Extension field.

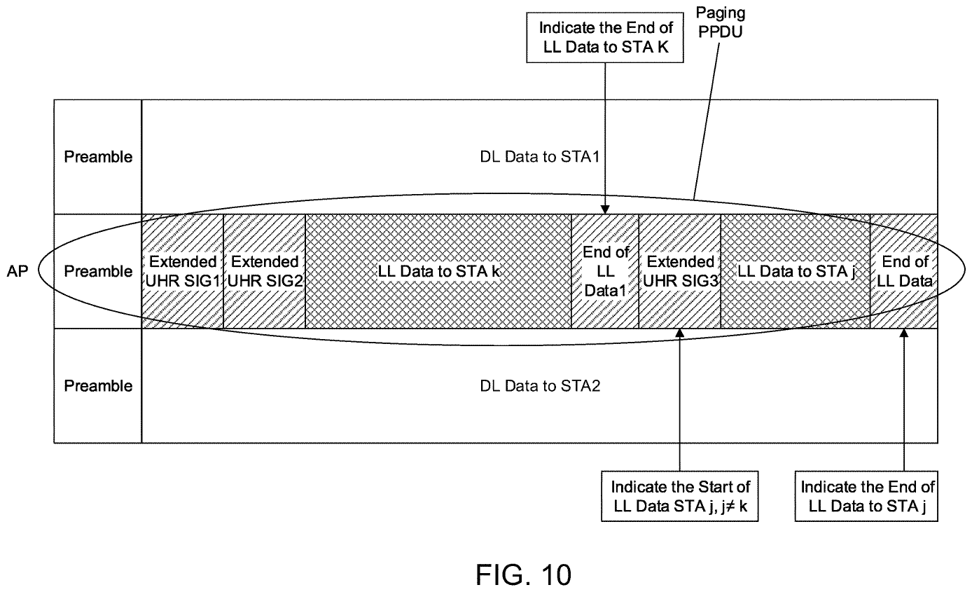

In an embodiment, a Paging PPDU may carry data to multiple STAs. FIG. 10 shows an example of a Paging PPDU that carries data to STA k and STA j, where kj. In this Paging PPDU, an End of LL Data1 field may be transmitted after LL Data to STA k. The End of LL Data1 field may indicate the end of LL Data field to STA k. The Extended UHR SIG3 field may follow the End of LL Data1 field and may indicate the intended receiver is STA j. The End of LL Data2 field may follow the Data field which carries the LL data to STA j. The End of LL Data2 field may align with the end of other DL PPDU transmissions.

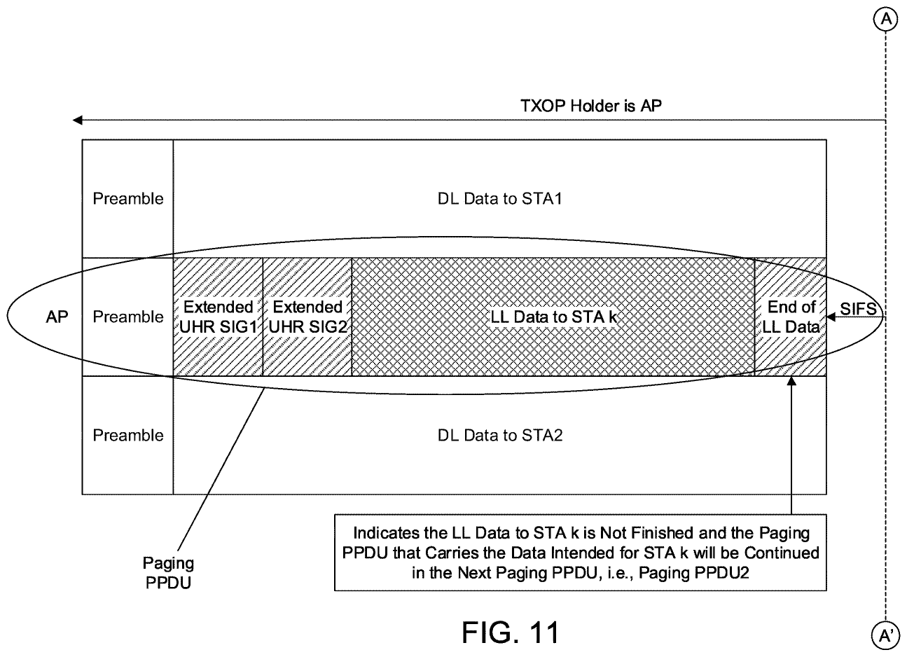

In some embodiments, the Paging PPDU may be transmitted in a TXOP. In an embodiment, if the LL data to a STA is not finished in the current PPDU, it may indicate the continued transmission in the next Paging PPDU within the same TXOP. FIG. 11 shows an example of the PPDU transmissions within a TXOP. In this embodiment, Paging PPDU2 is transmitted a SIFS after Paging PPDU1. The End of LL Data subfield of Paging PPDU1 may indicate that the LL data to STA k is not finished and the next Paging PPDU (i.e. Paging PPDU2) which is transmitted a SIFS after Paging PPDU1 will continue carrying the LL data to STA k. The bandwidth (BW) of the paging channel allocated to Paging PPDU2 in the coming DL transmission may not necessarily be the same as the BW of the paging channel allocated to Paging PPDU1. The BW of Paging PPDU2 may be the same or different from the BW of Paging PPDU1. The RU/channel allocations for Paging PPDU1 and Paging PPDU2 may be the same or different. The paging PPDU1 and paging PPDU2 may be transmitted to different STAs.

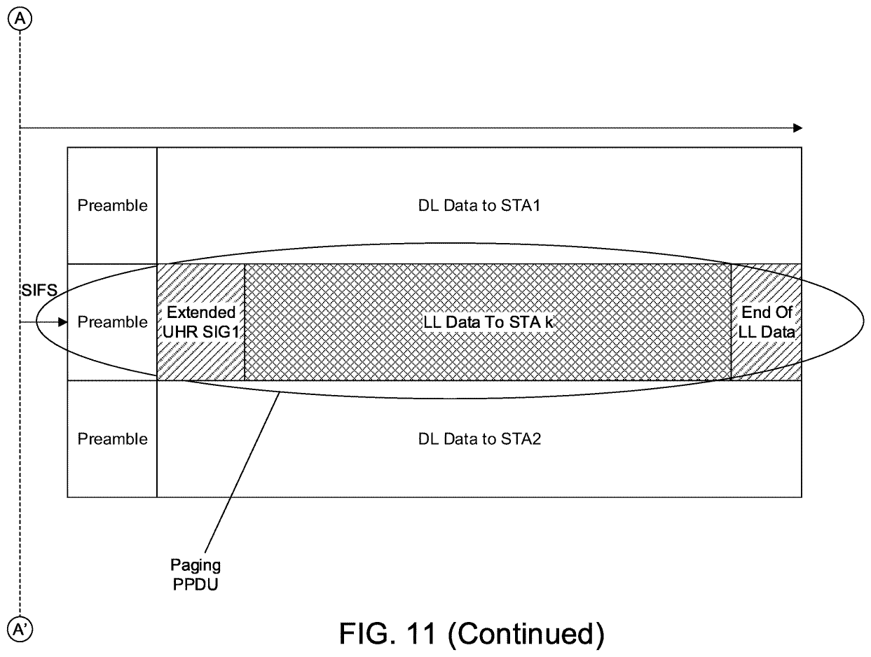

In some embodiments, a Low Latency (LL) Group ID Operation may be used. In an embodiment, a LL Group ID Management frame may be transmitted by an AP to indicate a group of STAs which are the potential receivers of the LL traffic (or a specific type of LL traffic) delivered in a Paging PPDU. A STA may be assigned to one or more groups. Different Group IDs may also indicate different types of LL traffic. This assignment may be indicated by a LL Traffic Membership Status Array. The LL Group ID Management frame may be sent as an individually addressed frame. Upon reception of the LL Group ID Management frame, the STA may identify the LL Group ID(s) that it belongs to. For example, a STA receives the LL Group ID Management frame and identifies that it belongs to LL Group 1 and LL Group 2. This may indicate that this STA is the potential receiver of LL Traffic Type 1 and LL Traffic Type 2. LL Traffic Type 1 and LL Traffic Type 2 may be the same or different. If any indication shows that LL Group 1 is the potential receiver of the paging PPDU, the STA that belongs to LL Group 1 may need to be in an active mode and decode the preambles of the Paging PPDU. FIG. 12 shows an example LL Traffic Membership Status Array format. Within the LL Traffic Membership Status Array field, a 1-bit Membership Status subfield for each LL group ID may be set as follows. The Membership Status subfield may be set to a value (e.g. 0) if the STA is not a member of the LL group. The Membership Status subfield may be set to a different value (e.g. 1) if the STA is a member of the LL group.

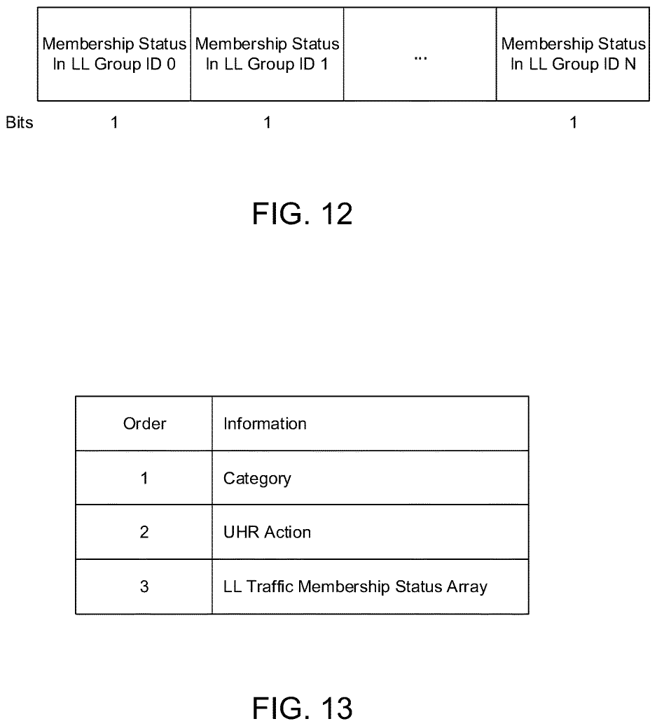

Transmission of a LL Group ID Management frame to a STA and an associated acknowledgement from the STA may be completed before the transmission of a Paging PPDU. FIG. 13 shows an example of a LL Group ID Management frame Action field.

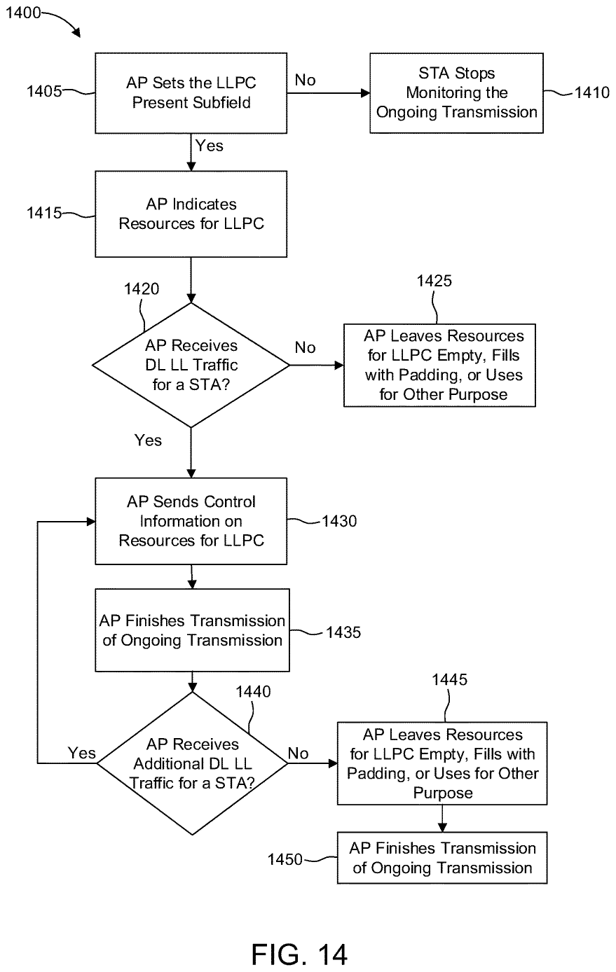

In an embodiment, a method for a transmitter supporting a LLPC is shown in FIG. 14. In FIG. 14, an AP is indicated as the transmitter, however a non-AP STA may act as the transmitter supporting the LLPC feature.

A transmitter STA (e.g. an AP) that supports a LLPC may set a subfield (e.g. LLPC Present subfield) in, for example, a U-SIG field or a UHR-SIG field, or any SIG field that may be used to signal information about the current PPDU, to a value (e.g. “1”) to indicate that the LLPC is present in the current packet or transmission or set it to a different value (e.g. “0”) to indicate that the LLPC is not present 1405.

If the LLPC is not present in the current packet or transmission, the STAs supporting the LLPC feature and that have no scheduled traffic in this packet or transmission may set their NAV according to the TXOP duration of the current packet and stop monitoring the channel and wait for the TXOP to lapse 1410.

If the LLPC is present in the current packet or transmission, the AP may indicate the resources for the LLPC 1415. The STAs supporting the LLPC feature may monitor the resources allocated for the LLPC only to save energy.

The AP may receive downlink (DL) low latency (LL) traffic for one or more STAs 1420. If the AP does not receive low latency traffic, it may leave the resources allocated to the LLPC empty, fill it with padding, or use it for another purpose 1425. The AP may continue the transmission of the ongoing packet or transmission until it finishes and then it may release the channel.

If the AP receives low latency traffic in the middle of the ongoing transmission, it may send control information on the resources allocated to the LLPC to the receiving STAs expecting low latency traffic 1430. The AP may send the low latency traffic 1435,

If the transmitter STA supporting LLPC receives more low latency traffic in the middle of the ongoing transmission 1440, it may send control information on the resources allocated to the LLPC to the receiving STAs expecting low latency traffic 1430, and may send the low latency traffic 1435. The AP may continue the transmission of the ongoing packet until it finishes and then release the channel.

If the AP does not receive more low latency traffic in the middle of the ongoing transmission 1440, the AP may leave the resources allocated to the LLPC empty, fill it with padding, or use it for another purpose 1445. The AP may continue the transmission of the ongoing packet until it finishes and then release the channel 1450.

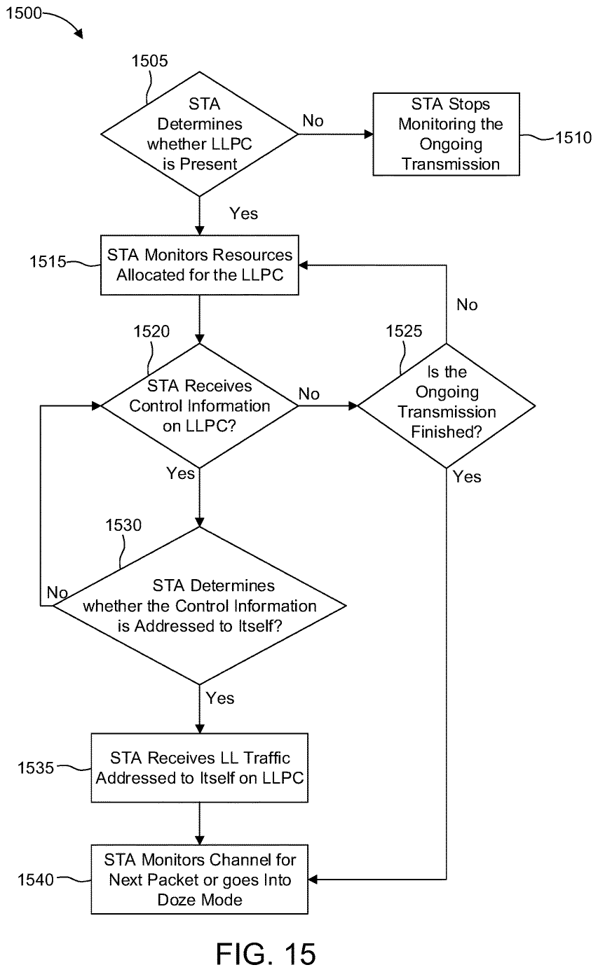

In an embodiment, a method for a receiver supporting the LLPC feature (e.g. STA) is shown in FIG. 15.

A STA that supports a LLPC may determine whether a LLPC is present in the ongoing transmission (i.e. current packet) 1505. The STA may check a LLPC Present subfield in the SIG field(s) in the current packet, for example a U-SIG subfield or UHR-subfield. If the LLPC Present subfield is set to a value that indicates no LLPC is present in the ongoing transmission (e.g. a value of 0), the STA supporting the LLPC feature may stop monitoring the channel or ongoing transmission and wait for the TXOP time to lapse 1510. If the LLPC Present subfield is set to a value that indicates a LLPC is present in the ongoing transmission (e.g. a value of 1), the STA supporting the LLPC feature may monitor the resources allocated for the LLPC 1515.

If the STA supporting the LLPC feature does not receive control information on the LLPC 1520 it may continue monitoring the LLPC until the ongoing transmission finishes. For example, if the STA does not receive control information on the LLPC, the STA may determine whether the ongoing transmission is finished 1525. If the ongoing transmission is not finished, the STA may continue monitoring the resources allocated for the LLPC 1515. If the ongoing transmission is finished, the STA may monitor the channel for a next packet or enter into a doze mode 1540.

If the STA supporting the LLPC feature receives control information on the LLPC 1520, it may decode the control information to determine if it is addressed as one of the STAs receiving low latency traffic (i.e. determine whether the control information is addressed to itself) 1530. If the STA supporting the LLPC feature is not addressed in the control information sent on the LLPC, it may continue monitoring the LLPC until the ongoing transmission finishes 1525. If the STA supporting the LLPC feature is addressed in the control information sent on the LLPC 1530, it may look for the information identifying the resources allocated to it on the LLPC to receive the low latency traffic 1535. The STA may then monitor the channel for a next packet or enter into a doze mode 1540.

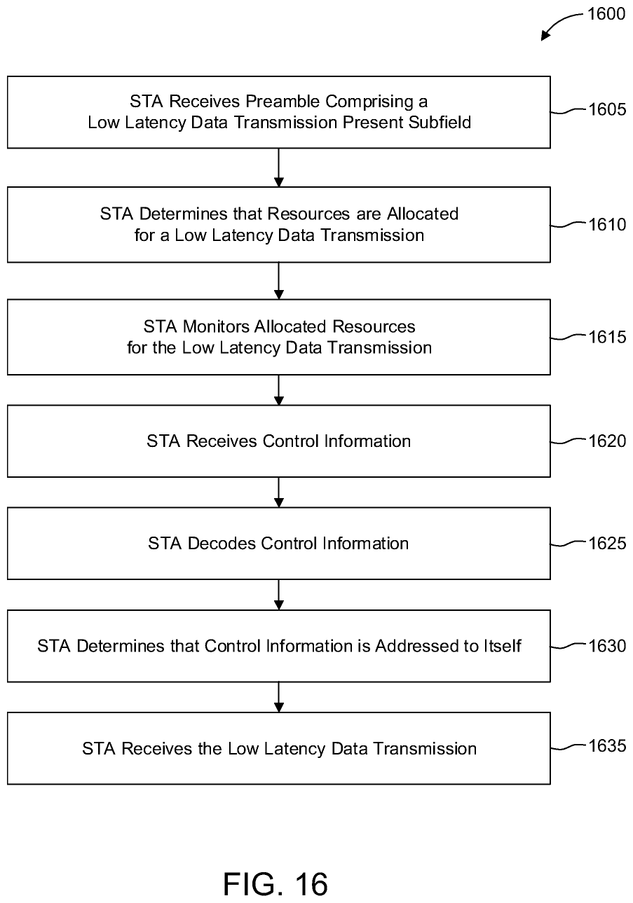

In an embodiment, a method for a receiver STA supporting a low latency data transmission is shown in FIG. 16. A STA that supports a low latency data transmission may receive a preamble that comprises a low latency data transmission resource present subfield 1605. The low latency data transmission resource present subfield may comprise an indication that indicates whether the low latency data transmission is present in an ongoing transmission or packet. The low latency data transmission resources may be a communication channel for a low latency data transmission (e.g. a low latency paging channel (LLPC)). The low latency data transmission resource present subfield may be in a U-SIG field or a UHR-SIG field.

The STA may determine that resources are allocated for a low latency (LL) data transmission in the ongoing transmission or packet 1610. That is the STA may determine that a low latency data transmission (e.g. LLPC) is present in the ongoing transmission. The STA may determine that resources are allocated for a low latency data transmission in the ongoing transmission or packet based on the low latency data transmission resource present subfield. For example, the low latency data transmission resource present subfield may be set to a value (e.g. a value of 1) that indicates that resources are allocated for a low latency data transmission in the ongoing transmission and the low latency data transmission resource present subfield may be set to a different value (e.g. a value of 0) that indicates that resources are not allocated for a low latency data transmission in the ongoing transmission. Resources allocated for the low latency data transmission may be static resources that are known to the STA. Resources allocated for the low latency data transmission may be dynamic and may be signaled to the STA in, for example, a SIG field of the preamble. The resources for low latency data transmission may be at least one or more orthogonal frequency division multiple access (OFDMA) resource units (RUS).

The STA may monitor allocated resources for the low latency data transmission 1615. The STA may receive control information 1620. The control information may be received in a physical layer protocol data unit (PPDU) in the allocated resources for the low latency data transmission. The PPDU may be a paging PPDU. The STA may decode the control information 1625. The STA may determine that the control information is addressed to itself 1630. The STA may receive the low latency data transmission over the allocated resources for the low latency data transmission based on the control information 1635. The low latency data transmission may be received in the PPDU.

WLAN APs are expected to be always in an active mode which may consume a significant amount of power. Enabling a Power Save Mode for an AP may be a desirable solution to reduce the carbon footprint of WLAN technology. However, the reliability and responsiveness of the AP in doze mode may be at stake especially for critical and low latency applications. Waking up an AP in a doze mode in case of low latency or critical uplink traffic is an open problem and procedures to enable this behavior are required. Paging to wake up an AP in a power save mode for uplink low latency traffic is needed.

In an embodiment, an AP may go into a doze mode to save power in scenarios where there is no traffic. A non-AP STA may send a wakeup signal to the AP in case there is low latency uplink traffic arrived at the non-AP STA. The wakeup signal may be received at the AP by a special or designated radio receiver that is designed for this purpose and is optimized for very small power consumption to wake up the AP in a very short time to be able to respond to low latency traffic or any type of traffic.

In an embodiment, the AP may announce, in a beacon frame or any management frame, that it is going into a doze mode and announce the schedule for the doze period. NDP Paging may then be setup between the AP and the non-AP STAs that may send wake up signals in the form of NDP Paging PPDUs to the AP when traffic arrives in the uplink.

In an embodiment, the AP may setup a small bandwidth resource to receive wakeup signals on this resource. Continuous monitoring of this resource may be optimized to minimize the power consumption of this AP. The resource allocated for waking up the AP may be announced in a beacon frame or any other management frame.

In an embodiment, a non-AP STA may send wakeup signals to its serving AP by sending a wakeup frame to another AP in a cooperative Multi-AP such that the other AP may send a wakeup packet to the serving AP through the DS in which these APs are connected by wired connections.

Although the features and elements of the present disclosure are described in the preferred embodiments in particular combinations, each feature or element can be used alone without the other features and elements of the preferred embodiments or in various combinations with or without other features and elements of the present disclosure.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although four RBs per triggered TXOP are shown in some figures as example, the actual number of RBs/channels/bandwidth utilized may vary.

Long Training Field (LTF) may be any type of predefined sequences that are known at both transmitter and receiver sides.

Many procedures are explained form the AP point of view, however it equally applies from the non-AP STA point of view.

Some signaling fields and subfields are set to 1 or 0 to signal a given indication may use any other setting of the subfields to signal the same indication.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for low latency communication, for a station (STA) that supports a low latency data transmission, the method comprising:
receiving a preamble that comprises a low latency data transmission resource present subfield;
determining, based on the low latency data transmission resource present subfield, that resources are allocated for a low latency data transmission;
monitoring the allocated resources for the low latency data transmission;
receiving control information in a physical layer protocol data unit (PPDU) in the allocated resources for the low latency data transmission;
decoding the received control information;
determining that the control information is addressed to the STA; and
receiving the low latency data transmission over the allocated resources for the low latency data transmission based on the control information.

2. The method of claim 1, wherein the low latency data transmission resource present subfield comprises an indication that indicates whether low latency data transmission resources are present.

3. The method of claim 1, wherein the low latency data transmission resource present subfield is in a U-SIG field or a UHR-SIG field.

4. The method of claim 1, wherein the allocated resources for the low latency data transmission are static resources and are known to the STA.

5. The method of claim 1, wherein the allocated resources for the low latency data transmission are signaled dynamically in a SIG field of the received preamble.

6. The method of claim 1, wherein the low latency data transmission is received in the PPDU.

7. The method of claim 1, wherein the PPDU is a paging PPDU.

8. The method of claim 1, wherein the resources for low latency data transmission is a communication channel for low latency data transmission.

9. The method of claim 1, wherein the resources for low latency data transmission is at least one or more orthogonal frequency division multiple access (OFDMA) resource units (RUS).

10. The method of claim 1, wherein the allocated resources for the low latency data transmission is a low latency paging channel (LLPC).

11. A station (STA) that supports a low latency data transmission, the STA comprising:
a receiver configured to receive a preamble that comprises a low latency data transmission resource present subfield;
a processor configured to determine, based on the low latency data transmission resource present subfield, that resources are allocated for a low latency data transmission;
the receiver and the processor are further configured to monitor the allocated resources for the low latency data transmission;
the receiver is further configured to receive control information in a physical layer protocol data unit (PPDU) in the allocated resources for the low latency data transmission;
the processor is further configured to decode the received control information;
the processor is further configured to determine that the control information is addressed to the STA; and
the receiver is further configured to receive the low latency data transmission over the allocated resources for the low latency data transmission based on the control information.

12. The STA of claim 11, wherein the low latency data transmission resource present subfield comprises an indication that indicates whether low latency data transmission resources are present.

13. The STA of claim 11, wherein the low latency data transmission resource present subfield is in a U-SIG field or a UHR-SIG field.

14. The STA of claim 11, wherein the allocated resources for the low latency data transmission are static resources and are known to the STA.

15. The STA of claim 11, wherein the allocated resources for the low latency data transmission are signaled dynamically in a SIG field of the received preamble.

16. The STA of claim 11, wherein the low latency data transmission is received in the PPDU.

17. The STA of claim 11, wherein the PPDU is a paging PPDU.

18. The STA of claim 11, wherein the resources for low latency data transmission is a communication channel for low latency data transmission.

19. The STA of claim 11, wherein the resources for low latency data transmission is at least one or more orthogonal frequency division multiple access (OFDMA) resource units (RUS).

20. The STA of claim 11, wherein the allocated resources for the low latency data transmission is a low latency paging channel (LLPC).
